(19) United States
(12) Patent Application Publication
(10) Pub. No.: US 2009/0068582 A1
(43) Pub. Date: Mar. 12, 2009

(54) DEVELOPER, IMAGE FORMING METHOD AND IMAGE FORMING APPARATUS

(75) Inventor: Hiroshi Kawaguchi, Kanagawa-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/204,186

(22) Filed: Sep. 4, 2008

Related U.S. Application Data
(60) Provisional application No. 60/970,562, filed on Sep. 7, 2007.
(60) Provisional application No. 60/970,565, filed on Sep. 7, 2007.

(51) Int. Cl. G03G 9/087; G03G 9/09; G03G 13/16; G03G 15/08

(52) U.S. Cl. 430/109.4; 430/111.4; 430/125.3; 399/222

(57) ABSTRACT

A developer includes a core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d>2.0 μm being present in a number of 1 or less per 10 particles of the core toner on observation of one sliced surface of the core toner, and inorganic oxide particles having a primary particle diameter of from 80 to 300 nm externally added to a surface of the core toner in an amount of from 0.1 to 5.0% by weight based on 100% by weight of the toner.

### CROSS-REFERENCE TO RELATED APPLICATION

This application is based upon and claims the benefit of priority from the prior U.S. Patent Applications No. 60/970,565 filed on Sep. 7, 2007 and 60/970,562 filed on Sep. 7, 2007, the entire contents of which are incorporated herein by reference.

### TECHNICAL FIELD

The present invention relates to a developer, an image forming method and an image forming apparatus used for forming an image through an electrophotographic system, for example, with a duplicator and a printer.

### BACKGROUND

In an image forming apparatus using an electrophotographic system, in general, a toner is formed into a visual image on an electrostatic latent image carrying member, such as a photoreceptor, and then attached to a desired position on a transfer medium, such as paper. The toner attached to the transfer medium is fixed to the transfer medium by pressing with a heat roller or the like to form an image on the transfer medium.

Color electrophotography uses toners of four colors including yellow, magenta, cyan and black. Among these, in particular, a magenta toner suffers a high discoloration rate and is difficult to provide good light resistance.

In recent years, a quinacridone pigment excellent in light resistance is being used in addition to a naphthol pigment. A quinacridone pigment is excellent also in blue color, and high blue reproducibility and light resistance can be obtained by appropriately mixing with the naphthol pigment. A quinacridone pigment on the other hand is poor in colorability and brings about deterioration in image quality due to shortage in image density.

In general, when the pigment in the toner has a large dispersed diameter, the colorability is decreased to make the image density short. Furthermore, the ratio of the pigment appearing on the surface of the toner is increased, and thus filming occurs to cause image failure. Accordingly, there is an attempt for attaining high image quality by decreasing the dispersed diameter of the pigment by a process, such as a pigment master batch, to increase the surface area.

However, the decrease of the dispersed diameter of the pigment brings about such a tendency that the light resistance of the pigment is lowered. Accordingly, there is a problem of difficulty of attaining both light resistance and high image quality simultaneously.

### SUMMARY

According to one aspect of the invention, there is provided a developer including a core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner, and inorganic oxide particles having a primary particle diameter of from 80 to 300 nm externally added to a surface of the core toner in an amount of from 0.1 to 5.0% by weight based on 100% by weight of the toner.

According to one aspect of the invention, there is provided an image forming method including, forming toner images with a yellow toner, a magenta toner, a cyan toner and a black toner on an image carrying member, wherein the magenta toner contains a core toner and inorganic oxide particles, the core toner containing a magenta colorant including a quinacridone pigment, the magenta colorant having a dispersed diameter d (major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner, the inorganic oxide particles having a primary particle diameter of from 80 to 300 nm externally added to a surface of the core toner in an amount of from 0.1 to 5.0% by weight based on 100% by weight of the toner, and transferring the toner images onto a transfer medium to form an image.

According to one aspect of the invention, there is provided an image forming apparatus including, an image carrying member configured to form toner images on the image carrying member with a yellow toner, a magenta toner, a cyan toner and a black toner, wherein the magenta toner contains a core toner and inorganic oxide particles, the core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner, the inorganic oxide particles having a primary particle diameter of from 80 to 300 nm externally added to a surface of the core toner in an amount of from 0.1 to 5.0% by weight based on 100% by weight of the toner, and a transfer medium configured to transfer the toner images.

It is to be understood that both the forgoing general description and the following detailed description are exemplary and explanatory only and are not restrictive of the invention, as claimed.

### DESCRIPTION OF THE DRAWINGS

The accompanying drawings, which is incorporated in and constitute a part of this specification, illustrates an embodiment of the invention and together with the description, serve to explain the principles of the invention.

FIG. 1A is a top conceptual view showing a master batch of a magenta toner according to an embodiment of the invention;

FIG. 1B is a partial conceptual view of a cross section on line A-A′ in FIG. 1A observed with a transmission electron microscope;

FIG. 2 is a conceptual view showing an image forming apparatus by a four-tandem process according to an embodiment of the invention;

FIG. 3 is a conceptual view showing an image forming apparatus having an intermediate transfer medium by a four-tandem process according to an embodiment of the invention;

FIG. 4 is a table showing evaluation results of formulations of toner particles of Examples according to embodiments of the invention and Comparative Examples; and

FIG. 5 is a table showing evaluation results of formulations of toner particles of Examples according to embodiments of the invention and Comparative Examples.

### DETAILED DESCRIPTION

Reference will now be made in detail to the present embodiment of the invention, an example of which is illustrated in the accompanying drawing.

A developer according to the embodiment includes core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner, and inorganic oxide particles having a primary particle diameter of from 80 to 300 nm externally added to a surface of the core toner in an amount of from 0.1 to 5.0% by weight based on 100% by weight of the toner.

An image forming method according to the embodiment includes forming toner images with a yellow toner, a magenta toner, a cyan toner and a black toner on an image carrying member, wherein the magenta toner contains a core toner and inorganic oxide particles, the core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner, the inorganic oxide particles having a primary particle diameter of from 80 to 300 nm externally added to a surface of the core toner in an amount of from 0.1 to 5.0% by weight based on 100% by weight of the toner, and transferring the toner images onto a transfer medium to form an image.

An image forming apparatus according to the embodiment an image carrying member configured to form toner images on the image carrying member with a yellow toner, a magenta toner, a cyan toner and a black toner, wherein the magenta toner contains a core toner and inorganic oxide particles, the core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner, the inorganic oxide particles having a primary particle diameter of from 80 to 300 nm externally added to a surface of the core toner in an amount of from 0.1 to 5.0% by weight based on 100% by weight of the toner, and a transfer medium configured to transfer the toner images.

The magenta toner used in the embodiment contains a magenta colorant containing a quinacridone pigment. Examples of the quinacridone pigment include Pigment Red 112 (PR 112). The additional amount of the quinacridone pigment is preferably from 10 to 90% by weight based on the magenta colorant. When the additional amount is less than 10% by weight, the reproducibility of blue may be deteriorated, and when it exceeds 90% by weight, the reproducibility of red may be deteriorated. The additional amount is more preferably from 30 to 70% by weight.

The quinacridone pigment preferably has a dispersed diameter d_{q} of 0.05≦d_{q}≦0.5 μm. When the dispersed diameter is less than 0.05 μm, the number of the pigment particles present on the surface of the toner is increased, and the number of the pigment particles present on the surface of the toner layer after fixing is also increased. Accordingly, the irregularity on the surface of the toner layer may be increased to deteriorate the smoothness thereon, which may lower the glossiness of the image formed. When the dispersed diameter exceeds 0.5 μm, on the other hand, the ratio of the pigment particles projecting from the surface of the toner may be increased to cause filming on a photoreceptor, and sufficient colorability may not be obtained. The dispersed diameter d_{q} is more preferably from 0.1 to 0.3 μm.

The magenta colorant preferably further contains a naphthol pigment. Examples of the naphthol pigment include Pigment Red 238 (PR 238). The naphthol pigment preferably has a dispersed diameter dₙ of dₙ>d_{q}. A naphthol pigment has higher colorability than a quinacridone pigment, but is low in light resistance. When dₙ≦d_{q}, the light resistance may be further decreased to lower the colorability upon irradiation of an ultraviolet ray or the like for a prolonged period of time.

The ratio Cₙ/C_{q} of the additional amount Cₙ of the naphthol pigment and the additional amount C_{q} of the quinacridone pigment is preferably from 8/2 to 2/8. When the proportion of the quinacridone pigment C_{q} is less than 2, sufficient reproducibility of blue and light resistance may not be obtained. When the proportion of the quinacridone pigment C_{q} exceeds 8, sufficient reproducibility of red may not be obtained. The ratio Cₙ/C_{q} is more preferably from 7/3 to 3/7.

The naphthol pigment preferably has a dispersed diameter dₙ of 0.1≦dₙ≦1.0 μm. When the dispersed diameter is less than 0.1 μm, sufficient light resistance may not be obtained. When it exceeds 1.0 μm, on the other hand, filming on a photo receptor may occur, and sufficient colorability may not be obtained. The dispersed diameter dₙ is more preferably from 0.3 to 0.5 μm.

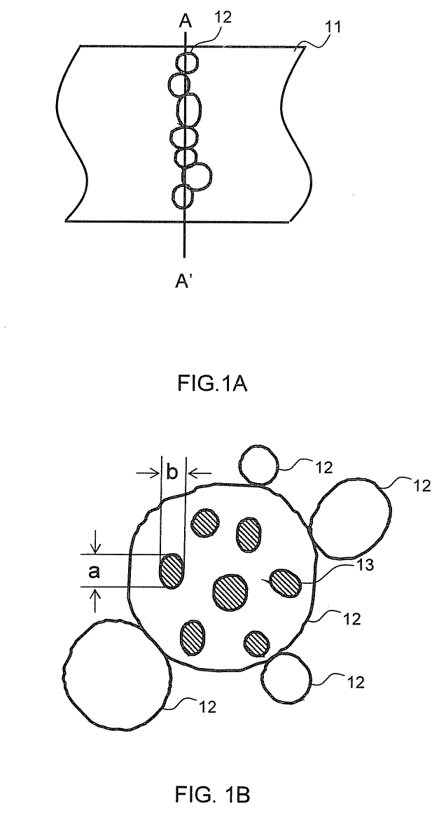

FIG. 1A is a top conceptual view showing a master batch of a magenta toner, and FIG. 1B is a partial conceptual view of the cross section on line A-A′ in FIG. 1A observed with a transmission electron microscope. In the master batch 11, the magenta colorant 13 having a dispersed diameter d=(major diameter a+minor diameter b)/2 of 0.25≦d≦0.50 μm is present in a number from 5 to 200 per 10 particles of the core toner on the sliced surface of the magenta toner (core toner) 12, and d≧2.0 μm is present in a number of 1 or less per 10 particles of the core toner on observation of one sliced surface of the core toner.

In the case that the number of the magenta colorant particles of 0.25≦d≦0.50 μm is less than 5, sufficient light resistance may not be obtained when the average diameter is smaller than the range. When the average diameter is larger than the range, filming on a photoreceptor may occur due to too large the pigment particles. When the number of the magenta colorant particles of 0.25≦d≦0.50 μm exceeds 200, or when the number of the magenta colorant particle of d≧2.0 μm is 2 or more, filming on a photoreceptor may occur, and sufficient colorability may not be obtained. The number of the magenta colorant particles of 0.25≦d≦0.50 μm is more preferably from 20 to 40, and the number of the magenta colorant particle of d≧2.0 μm is 0.

The magenta colorant particles are preferably contained in the toner in an amount of from 4 to 15% by weight. When the amount is less than 4% by weight, sufficient colorability may not be obtained. When it exceeds 15% by weight, filming on a photoreceptor may occur. The amount of the magenta colorant particles is more preferably from 6 to 8% by weight.

Preferred examples of the binder resin contained in the magenta toner include a polyester resin. A copolymer resin, such as a styrene copolymer, an acrylic copolymer and a styrene-acrylic copolymer, produced by a copolymerization method, and a cyclic olefin resin may be used in combination.

In particular, the magenta toner preferably contains a crystalline polyester resin in an amount of from 1 to 15% by weight based on the magenta toner. The crystalline polyester resin having a low softening point contained maintains smoothness on the surface of the toner layer to ensure the glossiness. When the amount of the crystalline polyester resin is less than 1% by weight, sufficient smoothness and glossiness may not be obtained. When it exceeds 15% by weight, the charge amount of the toner may be decreased particularly under a high temperature and high humidity environment, which may cause image failure. The amount of the crystalline polyester is more preferably from 3 to 7% by weight.

The magenta toner preferably further contains a releasing agent. Examples of the releasing agent include ester wax, for example, natural ester wax, such as carnauba wax and rice wax, and synthetic ester wax synthesized from a carboxylic acid and an alcohol.

A charge controlling agent for controlling the frictional charge amount may be contained. Examples of the charge controlling agent include a metal-containing azo compound. The metal-containing azo compound is preferably a complex compound or complex salt containing iron, cobalt or chromium as a metallic element, or a mixture thereof. Examples of the charge controlling agent also include a metal-containing salicylic acid derivative and a hydrophobic treated product of a metallic oxide. The metal-containing salicylic acid derivative and the hydrophobic treated product of a metallic oxide is preferably a complex compound or complex salt containing zirconium, zinc, chromium or born as a metallic element, or a mixture thereof.

The magenta core toner contains on the surface thereof inorganic oxide particles having a primary particle diameter of from 80 to 300 nm in an amount of from 0.1 to 5.0% by weight based on 100% by weight of the toner, for suppressing filming. Examples of the inorganic oxide particles include silica and also include titania, alumina, strontium titanate and tin oxide.

When the primary particle diameter of the inorganic oxide particles is less than 80 nm, the probability of the core toner being in contact with the surface of the photoreceptor may not be sufficiently lowered. When it exceeds 300 nm, fixing failure may occur. The primary particle diameter of the inorganic oxide particles is more preferably from 85 to 150 nm.

As an external additive, inorganic compound particles having a small diameter may be used in combination, and fine particles of a resin or fine particles of a metallic soap as a drum cleaner lubricant may be externally added.

The magenta toner (core toner) preferably has a volume average particle diameter of from 4.0 to 12.0 μm. When the volume average particle diameter is less than 4.0 μm, transferring failure may occur, and when it exceeds 12.0 μm, reproducibility of thin lines may be deteriorated. The volume average particle diameter of the magenta toner is more preferably from 5 to 8 μm.

The magenta toner may be produced by a known method, such as a pulverizing method or a chemical method, such as a polymerization method. In the pulverizing method, the raw materials including the binder resin, the releasing agent and the colorant are mixed and kneaded in a molten state. The kneaded product of the raw materials is pulverized and classified, and an external additive is added thereto to form the toner.

Examples of an apparatus for mixing and dispersing the raw materials include a mixer and a kneader. Examples of the mixer include Henschel Mixer (produced by Mitsui Mining Co., Ltd.), Super Mixer (produced by Kawata MFG Co., Ltd.), Ribocorn (produced by Okawara Corporation), Nauta Mixer, Tervurizer and Cyclomix (produced by Hosokawa Micron Co., Ltd.), Spiralpin Mixer (produced by Pacific Machinery & Engineering Co., Ltd.) and Lödige Mixer (produced by Matsubo Corporation). Mixers such as these can be used when an external additive is added.

Examples of the kneader include KRC Kneader (produced by Kurimoto, Ltd.), Buss Co-kneader (produced by Buss AG), Extruder Type TEM (produced by Toshiba Machine Co., Ltd.), TEX Biaxial Kneader (produced by Japan Steel Works, Ltd.), PCM Kneader (produced by Ikegai Corporation), Three-roll Mill, Mixing Roll Mill and Kneader (produced by Inoue Manufacturing Co., Ltd.), Kneadex (produced by Mitsui Mining Co., Ltd.), MS-type Pressure Kneader and Kneader-Ruder (produced by Moriyama Co., Ltd.) and Banbury Mixer (produced by Kobe Steel Co., Ltd.).

Examples of an apparatus for coarsely pulverizing the mixed product include a hammer mill, a cutter mill, a jet mill, a roller mill and a ball mill. Examples of an apparatus for finely pulverizing the coarsely pulverized product include a pulverizer. Examples of the pulverizer include Counter Jet Mill, Micronjet and Inomizer (produced by Hosokawa Micron Co., Ltd.), IDS-type Mill and PJM Jet Pulverizer (produced by Nippon Pneumatic Mfg. Co., Ltd.), Crossjet Mill (produced by Kurimoto, Ltd.), Ulmax (produced by Nisso Engineering Co., Ltd.), SK Jet-O-Mill (produced by Seishin Enterprise Co., Ltd.) Kryptron (produced by Kawasaki Heavy Industries, Ltd.) and Turbo Mill (produced by Turbo Kogyo Co., Ltd.).

Examples of the classifier for classifying the finely pulverized product include Classiel, Micron Classifier and Spedic Classifier (produced by Seishin Enterprise Co., Ltd.), Micron Separator, Turboplex ATP and TSP Separator (produced by Hosokawa Micron Co., Ltd.), Elbow-Jet (produced by Nittetsu Mining Co., Ltd.), Dispersion Separator (produced by Nippon Pneumatic Mfg. Co., Ltd.) and YM Microcut (produced by Yasukawa Shoji Co., Ltd.). Examples of a sieve apparatus for sieving coarse particles or the like include Ultrasonic (produced by Koei Sangyo Co., Ltd.), Resona Sieve and Gyro Sifter (produced by Tokuju Corporation), Vibrasonic System (produced by Dalton Corporation), Sonicreen (produced by Sintokogyo, Ltd.), Turbo Screener (produced by Turbo Kogyo Co., Ltd.), Microshifter (produced by Makino MFG Co., Ltd.) and a circular vibration sieve.

Upon forming toners including the magenta toner by using the apparatuses, the particle diameters of the pigments such as the naphthol pigment and the quinacridone pigment can be controlled by the mixing time upon mixing and the conditions for kneading. For example, the particle diameters can be controlled by the mixing time with a Henschel Mixer, and the conditions for forming a master batch with a three-roll kneader and for kneading with an extrusion melt kneading machine (such as the rotation numbers of the axes, the rate of charging the raw materials and the structure of the axes).

In the polymerization method, a pigment having a prescribed particle diameter and a mixture containing a binder resin and the like are formed into coarse particles, which are mixed with an aqueous medium to form a mixture, and the mixture is mechanically sheared to form fine particles, which are then aggregated to form the toner particles. The aggregated particles may be further fused depending on necessity in the process.

Preferred examples of a yellow colorant contained in a yellow toner used for forming an image along with the magenta toner include a monoazo pigment, such as Pigment Yellow 74 (PY 74).

Preferred examples of a cyan colorant contained in a cyan toner used for forming an image along with the magenta toner include a phthalocyanine pigment, such as Pigment Blue 15 (PB 15).

Preferred examples of a black colorant contained in a black toner used for forming an image along with the magenta toner include carbon black. Examples of the carbon black include acetylene black, furnace black, thermal black, channel black and Ketjen black.

The yellow toner, the cyan toner and the black toner may be similarly produced by using a binder resin, an external additive, a releasing agent, a charge controlling agent and the like that are similar to those used in the magenta toner.

The toners may each be used as a one-component developer as it is or may be used as a two-component developer by adding a magnetic carrier thereto. Examples of the magnetic carrier include magnetic particles of ferrite, magnetite, iron oxide or the like, resin particles containing the magnetic particles, and particles containing the magnetic particles having on at least a part of the surface thereof a resin coating, such as a fluorine resin, a silicone resin and an acrylic resin.

Examples of an image carrying member (electrostatic latent image carrying member) used in an image forming method and an image forming apparatus for forming an image with the toners on a transfer medium include a known photoreceptor, such as a positively charging or negatively charging OPC (organic photoconductor) and amorphous silicon. In the photoreceptor, a charge generating layer, a charge transporting layer and a protective layer may be laminated, or a layer having functions of plural layers among the layers may be laminated. The transfer medium is a medium, on which an image is finally formed, such as paper.

An image can be formed, for example, through the following electrophotographic process using the developer, the image forming method or the image forming apparatus.

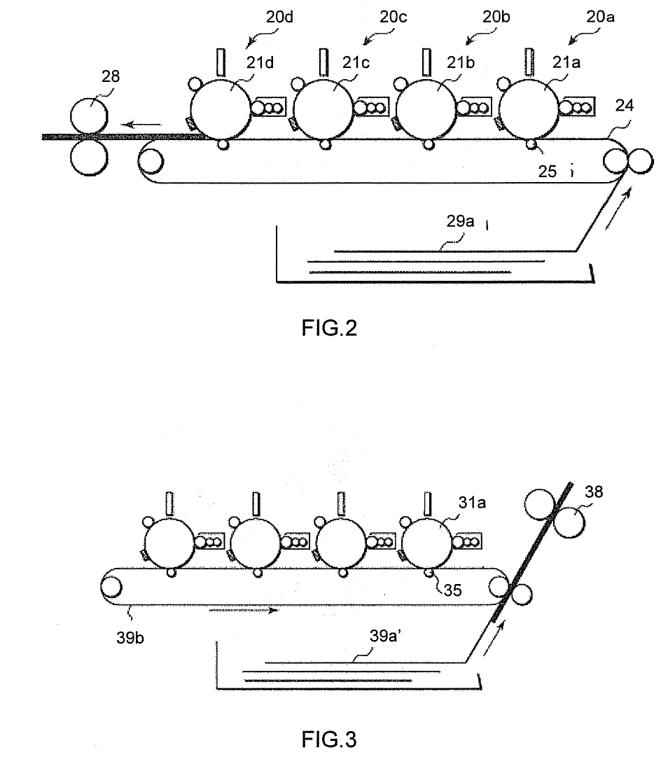

FIG. 2 is a conceptual view showing an image forming apparatus by a four-tandem process. As shown in the figure, image forming units 20a, 20b, 20c and 20d, each of which contains a developing device containing the yellow, magenta, cyan or black toner, a photoreceptor and charging, exposing and transferring devices, are provided for the four colors, and disposed in series along the transporting path of a transfer medium 29a. A fixing device 28 for fixing a toner image on paper is disposed. An image is formed through the following process by using the image forming apparatus. Herein, an example will be described, in which the image forming units for yellow, magenta, cyan and black are arranged in this order.

In the yellow image forming unit, a yellow toner image is formed on the photoreceptor 21a and transferred to the transfer medium 29a. In the case of a direct transferring system, paper or the like as the final transfer medium is transported with a transporting member, such as a transfer belt or roller, and fed to the transferring area of the yellow image forming unit. FIG. 2 shows such a constitution that an image is transferred with a transfer roller 25 onto paper transported with a transfer belt 24 as the transporting member. Examples of the transferring system include a known transferring system, such as a transfer roller, a transfer blade and a corona charger.

At the transferring position, the transfer belt 24 in contact with the photoreceptor 21a is pressed onto the photoreceptor 21a with a transfer roller 25, and a transfer bias voltage having a prescribed magnitude and a prescribed polarity is applied with a transfer bias power source between the transfer roller 25 and the transfer medium 29 disposed between the transfer belt 24 and the photoreceptor 21a. The application of the transfer bias voltage transfers the toner image (toner) attached to the outer surface of the photoreceptor 21a onto the transfer medium 29a through attraction toward the transfer medium 29a.

An intermediate transfer belt 39b as an intermediate transfer medium may be provided as shown in FIG. 3. The intermediate transfer belt 39b may be a semiconductive member having a thickness of from 50 to 3,000 μm constituted by a resin, rubber or a laminated body thereof, and a transfer roller 35 (transferring device) is in contact with the belt on the opposite side to the photoreceptor 31a. A prescribed transfer bias voltage is applied to the transfer roller 35 from a transfer bias voltage power source, whereby a transfer electric field is formed at and around a transfer nip part where the photoreceptor 31a and the intermediate transfer belt 39b are in contact with each other.

In the embodiment, a transfer roller 35 using semiconductive sponge having a volume resistivity of from 10⁵ to 10⁹ Ω·cm is made in contact with the backside of the belt, and a direct current voltage of from 300 to 3,000 V is applied to the transfer roller 35, whereby a toner image on the photoreceptor of the processing unit is transferred onto the intermediate transfer belt 39b. Four process units having the similar structure are arranged and transfer the images overlapped to form a full color image. Thereafter, the image is transferred onto a transfer medium 49a′, such as paper, at the secondarily transferring position and then fixed by heating with a fixing device 38 to form a final image.

The intermediate transfer belt 39b may have the same constitution in material and structure as the transfer belt 24. The surface resistance of the intermediate transfer belt is preferably from 10⁷ to 10¹² Ω·cm, and is, for example, 10⁹ Ω·cm.

In the magenta image forming unit 20b, a magenta toner image is formed on the photoreceptor 21b. The transfer medium 29a having the yellow toner image transferred thereon is fed to the transferring area of the magenta image forming unit 20b, and the magenta toner image is transferred onto the yellow toner image by positioning. The yellow toner on the transfer medium thus transported may sometimes be reversely transferred to the magenta photoreceptor 21b through contact with the magenta photoreceptor 21b depending on the magnitudes of the toner charge amount and the transfer electric field.

In the cyan and black image forming units 20c and 20d, toner images are similarly formed and transferred sequentially onto the transfer medium 29b by overlapping. To the cyan and black photoreceptors 21c and 21d, the toners of the preceding steps may sometimes be reversely transferred, respectively.

The transfer medium 29a having the toner images of four colors transferred thereon is peeled off from the transporting member and fed to the fixing device 28, and the images are fixed by a known heat-pressure fixing system using a heat roller or the like. In the case using the intermediate transfer medium 39b (FIG. 3), the toner images of four colors are transferred at one time with the secondarily transferring device onto the final transfer medium 39a′, such as paper, which is then fed to the fixing device 38 for fixing the images. The transfer media 29a and 39a′ having the toner image fixed thereon are then discharged outside the apparatus.

In the image forming units, the photoreceptors 31a, 31b, 31c and 31d are destaticized, and the toner remaining after transferring and the reversely transferred toner are removed by a cleaning process. The photoreceptors then return to the image forming process. In the developing device, the relative concentrations of the toners are adjusted.

While the embodiment shows an example where the image forming units for yellow, magenta, cyan and black are arranged in this order, the order of the colors is not limited thereto.

The invention will be described specifically with reference to examples.

### EXAMPLE 1

A polyester resin as a binder resin was mixed with carnauba wax as a releasing agent in an amount of 4% by weight, a charge controlling agent in an amount of 1.5% by weight and a magenta colorant, all based on the weight of the toner as 100% by weight, and mixed with a Henschel mixer. The mixed material was kneaded with a three-roll mixer and an extrusion melt kneading machine. As the magenta colorant, two kinds of pigments, i.e., a quinacridone pigment and a naphthol pigment, were used. The amount of the quinacridone pigment was 10% by weight based on the magenta colorant. The particle diameters of the naphthol pigment and the quinacridone pigment were controlled by the mixing time upon mixing and the conditions for kneading.

The master batch thus obtained by kneading was then pulverized and classified to provide a core toner of a magenta toner. The core toner was mixed with titanium oxide having a primary particle diameter of 15 nm in an amount of 0.5%, silica having a primary particle diameter of 20 nm in an amount of 1%, silica having a large particle diameter of 100 nm in an amount of 1% by weight as the inorganic oxide particles having a primary particle diameter of from 80 to 300 nm, and a metallic soap as a drum cleaner lubricant in an amount of 0.1% as external additives, all based on the weight of the toner as 100% by weight, and mixed with a Henschel mixer for a prescribed period of tome to provide a toner.

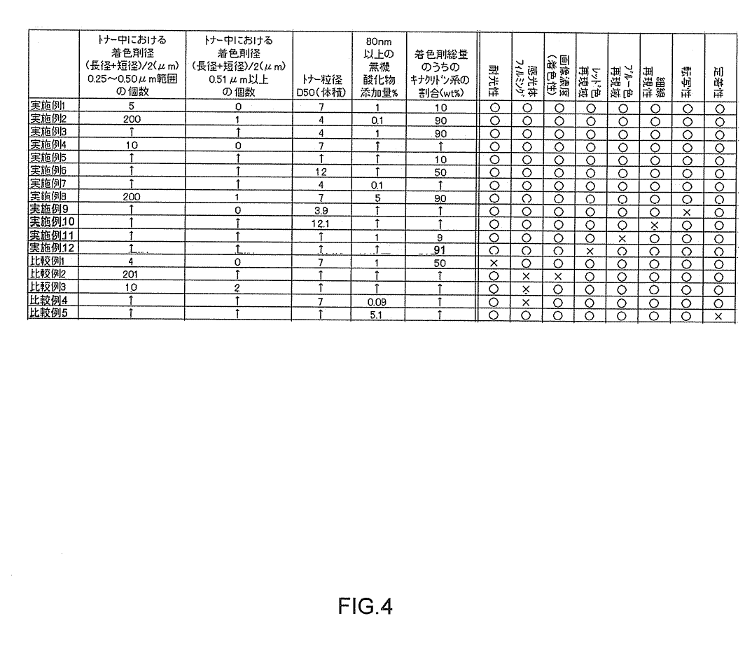

In the toner thus produced, as shown in FIG. 4, the magenta colorant that had a dispersed diameter d=(major diameter a+minor diameter b)/2 of 0.25≦d≦0.50 μm was present in a number of 5 per 10 particles of the core toner, and the magenta colorant that had a dispersed diameter d of d≧2.0 μm was not present in a number of 0 per 10 particles of the core toner. The toner had a volume average particle diameter D50 of 7 μm.

The magenta toner to be formed was mixed with a carrier to a toner content of 7.0% by weight to provide developers, with which an image was formed under the following conditions by using a multifunction printer e-STUDIO 3500C, produced by Toshiba Corporation, as an image forming apparatus. The image thus output was evaluated in the following manners.

### [Evaluation of Reproducibility of Blue]

The amounts of the magenta toner thus obtained and a cyan toner for testing (a cyan toner for e-STUDIO 3500C) on the photoreceptor were adjusted to 0.5 mg/cm by controlling the developing voltages, and an image having two colors overlapping was output. The chromatic coordinate thereof was measured with a calorimeter, produced by X-Rite GmbH. A square root of a sum of a* and b* of 47 or more was evaluated as A (good), and that of less than 47 was evaluated as C (poor).

### [Evaluation of Reproducibility of Red]

The amounts of the magenta toner thus obtained and a yellow toner for testing (a yellow toner for e-STUDIO 3500C) on the photoreceptor were adjusted by controlling the developing voltages as similar to the evaluation of reproducibility of blue, and an image having two colors overlapping was output. The chromatic coordinate thereof was measured with a calorimeter, produced by X-Rite GmbH. A square root of a sum of a* and b* of 79 or more was evaluated as A (good), and that of less than 79 was evaluated as C (poor).

### [Evaluation of Image Density]

A magenta monochrome solid image was output with a developing voltage controlled as similar to the evaluation of reproducibility of blue under an environment of a temperature of 20° C. and a humidity of 50%. The image was measured for image density with a Macbeth densitometer Model 19I. A measured value of 1.3 or more was evaluated as A (good), and that of less than 1.3 was evaluated as C (poor).

### [Evaluation of Light Resistance]

The solid image thus output in the evaluation of image density was subjected to 50-hour continuous irradiation with a light resistance tester (with xenon lamp, Suntest CPS+, produced by Atlas Material Testing Technology Corporation) under conditions of 550 W/m² and 35° C. with a filter containing a quartz filter (having infrared reflection coating) and a window glass filter. The image after irradiation was measured for image density with a Macbeth densitometer Model 19I. An image density maintenance ratio (((image density after irradiation)/(image density before irradiation))×100%) of 95% or more was evaluated as A (good), and that of less than 95% was evaluated as C (poor).

### [Evaluation of Filming on Photoreceptor]

A test chart having a print density of 10% was printed to form a magenta monochrome image under an environment of a temperature of 20° C. and a humidity of 50% by controlling the developing voltage in the same manner as in the evaluation of reproducibility of blue. After printing on 50,000 sheets of A4 size paper, a case where no filming on a photoreceptor occurred was evaluated as A (good), and a case where filming occurred was evaluated as C (poor).

### [Evaluation of Reproducibility of Thin Lines]

A thin line chart was printed to form a magenta monochrome thin line image under an environment of a temperature of 20° C. and a humidity of 50% by controlling the developing voltage in the same manner as in the evaluation of image density. In the thin lines thus output, a case where breakage or collapse of thin lines was found was evaluated as C (poor), and a case where no breakage or collapse was found was evaluated as A (good).

### [Evaluation of Transferring Property]

A magenta monochrome solid image was output under an environment of a temperature of 20° C. and a humidity of 50% by controlling the developing voltage in the same manner as in the evaluation of image density. The amount of the toner remaining on the photoreceptor after transferring was measured. A case where the transferring rate with respect to the toner amount before transferring of 0.5 mg/cm² was 95% or more was evaluated as A (good), and a case where the transferring rate was less than 95% was evaluated as C (poor).

### [Evaluation of Fixing Property]

In the solid image output in the evaluation of image density, a case where no fixing failure occurred was evaluated as A (good), and a case where fixing failure occurred was evaluated as C (poor).

The evaluation results are also shown in FIG. 4. As shown in FIG. 4, the number of the magenta colorant particles having a dispersed diameter d=(major diameter a+minor diameter b)/2 of 0.25≦d≦0.50 μm per 10 particles of the core toner was set at the lower limit of the prescribed range, and the additional amount of the quinacridone pigment was small, which were conditions disadvantageous for light resistance and reproducibility of blue. The number of the magenta colorant particles having a dispersed diameter d of 2.0 μm or more and the additional amount of the inorganic oxide particles having a primary particle diameter of from 80 to 300 nm were controlled to the optimum values. Satisfactory characteristics were obtained in all the evaluations.

### EXAMPLE 2

A magenta toner was produced under the conditions shown in FIG. 4 in the same manner as in Example 1. As shown in FIG. 4, the number of the magenta colorant particles having a dispersed diameter d of 0.25≦d≦0.50 μm was set at the upper limit of the prescribed range, the additional amount of the inorganic oxide particles having a primary particle diameter of from 80 to 300 nm was set at the lower limit of the prescribed range, the toner had a small particle diameter of 4 μm, and the additional amount of the quinacridone pigment was large, which were conditions disadvantageous for filming on a photoreceptor, image density, transferring property and reproducibility of red. The number of the magenta colorant particles having a dispersed diameter d of 2.0 μm or more was controlled to the optimum value. Satisfactory characteristics were obtained in all the evaluations.

### EXAMPLE 3

A magenta toner was produced under the conditions shown in FIG. 4 in the same manner as in Example 1. As shown in FIG. 4, the number of the magenta colorant particles having a dispersed diameter d of 0.25≦d≦0.50 μm and the number of the magenta colorant particles having a dispersed diameter d of 2.0 μm or more were set at the upper limits of the prescribed ranges, and the additional amount of the quinacridone pigment was large, which were conditions disadvantageous for filming on a photoreceptor, image density and reproducibility of red. The additional amount of the inorganic oxide particles having a primary particle diameter of from 80 to 300 nm was controlled to the optimum value. Satisfactory characteristics were obtained in all the evaluations.

### EXAMPLES 4 AND 5

A magenta toner was produced under the conditions shown in FIG. 4 in the same manner as in Example 1. As shown in FIG. 4, the additional amount of the quinacridone pigment was relatively large or relatively small, which was a condition disadvantageous for reproducibility of red or reproducibility of blue. The number of the magenta colorant particles having a dispersed diameter d of 0.25≦d≦0.50 μm, the number of the magenta colorant particles having a dispersed diameter d of 2.0 μm or more, the particle diameter of the toner and the additional amount of the inorganic oxide particles having a primary particle diameter of from 80 to 300 nm were controlled to the optimum values. Satisfactory characteristics were obtained in all the evaluations.

### EXAMPLE 6

A magenta toner was produced under the conditions shown in FIG. 4 in the same manner as in Example 1. As shown in FIG. 4, the particle diameter of the toner was large, which was a condition disadvantageous for reproducibility of blue. The number of the magenta colorant particles having a dispersed diameter d of 0.25≦d≦0.50 μm, the number of the magenta colorant particles having a dispersed diameter d of 2.0 μm or more, the additional amount of the inorganic oxide particles having a primary particle diameter of from 80 to 300 nm and the additional amount of the quinacridone pigment were controlled to the optimum values. Satisfactory characteristics were obtained in all the evaluations.

### EXAMPLE 7

A magenta toner was produced under the conditions shown in FIG. 4 in the same manner as in Example 1. As shown in FIG. 4, the additional amount of the inorganic oxide particles having a primary particle diameter of from 80 to 300 nm was set at the lower limit of the prescribed range, and the particle diameter of the toner was small, which were conditions disadvantageous for transferring property. The number of the magenta colorant particles having a dispersed diameter d of 0.25≦d≦0.50 μm, the number of the magenta colorant particles having a dispersed diameter d of 2.0 μm or more and the additional amount of the quinacridone pigment were controlled to the optimum values. Satisfactory characteristics were obtained in all the evaluations.

### EXAMPLE 8

A magenta toner was produced under the conditions shown in FIG. 4 in the same manner as in Example 1. As shown in FIG. 4, the number of the magenta colorant particles having a dispersed diameter d of 0.25≦d≦0.50 μm, the number of the magenta colorant particles having a dispersed diameter d of 2.0 μm or more and the additional amount of the inorganic oxide particles having a primary particle diameter of from 80 to 300 nm were set at the upper limits of the prescribed ranges, which were conditions disadvantageous for fixing property. The additional amount of the quinacridone pigment and the particle diameter of the toner were controlled to the optimum values. Satisfactory characteristics were obtained in all the evaluations.

### EXAMPLE 9

A magenta toner was produced under the conditions shown in FIG. 4 in the same manner as in Example 1. As shown in FIG. 4, the particle diameter of the toner was small. The number of the magenta colorant particles having a dispersed diameter d of 0.25≦d≦0.50 μm, the number of the magenta colorant particles having a dispersed diameter d of 2.0 μm or more, the additional amount of the inorganic oxide particles having a primary particle diameter of from 80 to 300 nm and the additional amount of the quinacridone pigment were controlled to the optimum values. While the transferring property was not satisfactory due to poor transferring property of the toner having a particle diameter of less than 4.0 μm, good results were obtained in all the other evaluations.

### EXAMPLE 10

A magenta toner was produced under the conditions shown in FIG. 4 in the same manner as in Example 1. As shown in FIG. 4, the particle diameter of the toner was large. The number of the magenta colorant particles having a dispersed diameter d of 0.25≦d≦0.50 μm, the number of the magenta colorant particles having a dispersed diameter d of 2.0 μm or more, the additional amount of the inorganic oxide particles having a primary particle diameter of from 80 to 300 nm and the additional amount of the quinacridone pigment were controlled to the optimum values. While the reproducibility of thin lines was not satisfactory due to the toner having a particle diameter exceeding 12.0 μm, good results were obtained in all the other evaluations.

### EXAMPLE 11

A magenta toner was produced under the conditions shown in FIG. 4 in the same manner as in Example 1. As shown in FIG. 4, the particle diameter of the toner was large and the additional amount of the quinacridone pigment was small. The number of the magenta colorant particles having a dispersed diameter d of 0.25≦d≦0.50 μm, the number of the magenta colorant particles having a dispersed diameter d of 2.0 μm or more and the additional amount of the inorganic oxide particles having a primary particle diameter of from 80 to 300 nm were controlled to the optimum values. While the hue of the toner was too reddish to fail to provide satisfactory reproducibility of blue due to the additional amount of the quinacridone pigment of less than 10% by weight, good results were obtained in all the other evaluations.

### EXAMPLE 12

A magenta toner was produced under the conditions shown in FIG. 4 in the same manner as in Example 1. As shown in FIG. 4, the additional amount of the quinacridone pigment was large. The number of the magenta colorant particles having a dispersed diameter d of 0.25≦d≦0.50 μm, the number of the magenta colorant particles having a dispersed diameter d of 2.0 μm or more, the additional amount of the inorganic oxide particles having a primary particle diameter of from 80 to 300 nm and the particle diameter of the toner were controlled to the optimum values. While the hue of the toner was too bluish to fail to provide satisfactory reproducibility of red due to the additional amount of the quinacridone pigment exceeding 90% by weight, good results were obtained in all the other evaluations.

### COMPARATIVE EXAMPLE 1

A magenta toner was produced under the conditions shown in FIG. 4 in the same manner as in Example 1. As shown in FIG. 4, the number of the magenta colorant particles having a dispersed diameter d of 0.25≦d≦0.50 μm was set at a value lower than the lower limit of the prescribed range. As a result, the light resistance was insufficient.

### COMPARATIVE EXAMPLE 2

A magenta toner was produced under the conditions shown in FIG. 4 in the same manner as in Example 1. As shown in FIG. 4, the number of the magenta colorant particles having a dispersed diameter d of 0.25≦d≦0.50 μm was set at a value exceeding the upper limit of the prescribed range. As a result, filming on a photoreceptor occurred, and an intended image density was not obtained due to insufficient colorability.

### COMPARATIVE EXAMPLE 3

A magenta toner was produced under the conditions shown in FIG. 4 in the same manner as in Example 1. As shown in FIG. 4, the number of the magenta colorant particles having a dispersed diameter d of 2.0 μm or more was set at a value exceeding the upper limit of the prescribed range. As a result, filming on a photoreceptor occurred.

### COMPARATIVE EXAMPLE 4

A magenta toner was produced under the conditions shown in FIG. 4 in the same manner as in Example 1. As shown in FIG. 4, the additional amount of the inorganic oxide particles having a primary particle diameter of from 80 to 300 nm was set at a value lower than the lower limit of the prescribed range. As a result, filming on a photoreceptor occurred.

### COMPARATIVE EXAMPLE 5

A magenta toner was produced under the conditions shown in FIG. 4 in the same manner as in Example 1. As shown in FIG. 4, the additional amount of the inorganic oxide particles having a primary particle diameter of from 80 to 300 nm was set at a value exceeding the upper limit of the prescribed range. As a result, the fixing property was insufficient.

### EXAMPLE 13

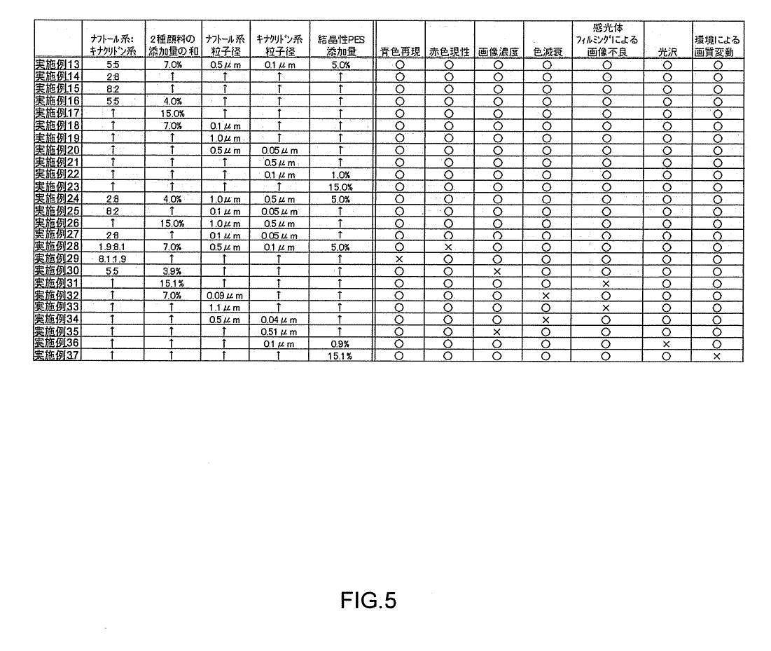

A magenta toner was produced in the same manner as in Example 1. As the binder resin, a crystalline polyester resin was added in an amount of 5.0% by weight based on the magenta toner as 100% by weight as shown in FIG. 5. The magenta colorant was prepared to have a ratio of additional amount of the naphthol pigment and the quinacridone pigment of 5/5 and an additional amount of the magenta colorant (total amount of the naphthol pigment and the quinacridone pigment) of 7.0% by weight, as shown in FIG. 5.

A magenta toner having a dispersed diameter of the naphthol pigment of 0.5 μm and a dispersed diameter of the quinacridone pigment of 0.1 μm was produced by appropriately controlling the kneading conditions and the like.

The magenta toner was mixed with a carrier to a toner content of 7.0% by weight to provide developers in the same manner as in Example 1, and an image formed with the developer was subjected to the evaluation of reproducibility of blue, the evaluation of reproducibility of red, the evaluation of image density, the evaluation of light resistance and the evaluation of filming on a photoreceptor. Furthermore, the image was subjected to the following evaluations.

### [Evaluation of Glossiness]

The solid image output in the evaluation of image density was measured for glossiness at a measurement angle of 60° with Gloss Meter VG2000. A measured value of 8 or more was evaluated as A (good), and that of less than 8 was evaluated as C (poor).

### [Evaluation of Image Fluctuation on Environments]

The developing voltage was controlled in the same manner as in the evaluation of reproducibility of blue under an environment of a temperature of 20° C. and a humidity of 50%. The test machine was placed in a thermostat chamber at a temperature of 30° C. and a humidity of 85%, and after allowing to stand for 10 hours, a magenta monochrome solid image was output. The solid image was measured for image density in the same manner as in the evaluation of image density. Separately, the test machine was placed in a thermostat chamber at a temperature of 10° C. and a humidity of 20%, and after allowing to stand for 10 hours, a magenta monochrome solid image was output. The solid image was measured for image density in the same manner as in the evaluation of image density. A case where the difference in image density between the environment of a temperature of 30° C. and a humidity of 85% and the environment of a temperature of 10° C. and a humidity of 20% was less than 0.3 was evaluated as A (good), and a case where the difference was 0.3 or more was evaluated as C (poor).

The evaluation results are also shown in FIG. 5. As shown in FIG. 5, the ratio of the additional amounts and the dispersed diameters of the naphthol pigment and the quinacridone pigment, the additional amount of the magenta colorant and the additional amount of the crystalline polyester resin were controlled to the optimum values. Satisfactory characteristics were obtained in all the evaluations.

### EXAMPLES 14 AND 15

A magenta toner was produced under the conditions shown in FIG. 5 in the same manner as in Example 13. As shown in FIG. 5, the ratio of the additional amounts of the naphthol pigment and the quinacridone pigment was 2/8 or 8/2. The dispersed diameters of the naphthol pigment and the quinacridone pigment, the additional amount of the magenta colorant and the additional amount of the crystalline polyester resin were controlled to the optimum values. Satisfactory characteristics were obtained in all the evaluations.

### EXAMPLE 16 AND 17

A magenta toner was produced under the conditions shown in FIG. 5 in the same manner as in Example 13. As shown in FIG. 5, the additional amount of the magenta colorant was 4.0% by weight or 15.0% by weight. The ratio of the additional amounts of the naphthol pigment and the quinacridone pigment, the dispersed diameters of the pigments and the additional amount of the crystalline polyester resin were controlled to the optimum values. Satisfactory characteristics were obtained in all the evaluations.

### EXAMPLES 18 AND 19

A magenta toner was produced under the conditions shown in FIG. 5 in the same manner as in Example 13. As shown in FIG. 5, the dispersed diameter of the naphthol pigment was 0.1 μm or 1.0 μm. When the dispersed diameter of the naphthol pigment was large, only the naphthol pigment was added in the later stage upon mixing before kneading, whereby the mixing time for the naphthol pigment was short. When the dispersed diameter of the naphthol pigment was small, only the naphthol pigment was formed into a master batch.

The ratio of the additional amounts of the naphthol pigment and the quinacridone pigment, the dispersed diameter of the quinacridone pigment, the additional amount of the magenta colorant and the additional amount of the crystalline polyester resin were controlled to the optimum values. Satisfactory characteristics were obtained in all the evaluations.

### EXAMPLES 20 AND 21

A magenta toner was produced under the conditions shown in FIG. 5 in the same manner as in Example 13. As shown in FIG. 5, the dispersed diameter of the quinacridone pigment was 0.05 μm or 0.5 μm. When the dispersed diameter of the quinacridone pigment was large, only the quinacridone pigment was added in the later stage upon mixing before kneading, whereby the mixing time for the quinacridone pigment was short. When the dispersed diameter of the quinacridone pigment was small, only the quinacridone pigment was formed into a master batch.

The ratio of the additional amounts of the naphthol pigment and the quinacridone pigment, the dispersed diameter of the naphthol pigment, the additional amount of the magenta colorant and the additional amount of the crystalline polyester resin were controlled to the optimum values. Satisfactory characteristics were obtained in all the evaluations.

### EXAMPLES 22 AND 23

A magenta toner was produced under the conditions shown in FIG. 5 in the same manner as in Example 13. As shown in FIG. 5, the additional amount of the crystalline polyester resin was 1.0% by weight or 15.0% by weight. The ratio of the additional amounts of the naphthol pigment and the quinacridone pigment, the dispersed diameters of the pigments and the additional amount of the magenta colorant were controlled to the optimum values. Satisfactory characteristics were obtained in all the evaluations.

### EXAMPLES 24 TO 27

A magenta toner was produced under the conditions shown in FIG. 5 in the same manner as in Example 13. The magenta toner was produced in such a manner that the ratio of the additional amounts of the naphthol pigment and the quinacridone pigment was set at the upper limit or the lower limit of the range of from 8/2 to 2/8, the dispersed diameter of the naphthol pigment was set at the upper limit or the lower limit of the range of from 0.1 to 1.0 μm, the dispersed diameter of the quinacridone pigment was set at the upper limit or the lower limit of the range of from 0.05 to 0.5 μm, the additional amount of the magenta colorant was set at the upper limit or the lower limit of the range of from 4.0 to 15.0% by weight, and the additional amount of the crystalline polyester resin was set at the upper limit or the lower limit of the range of from 1.0 to 15.0% by weight. Satisfactory characteristics were obtained in all the evaluations.

### EXAMPLE 28

A magenta toner was produced under the conditions shown in FIG. 5 in the same manner as in Example 13. As shown in FIG. 5, the ratio of the additional amounts of the naphthol pigment and the quinacridone pigment was 1.9/8.1. The dispersed diameters of the naphthol pigment and the quinacridone pigment, the additional amount of the magenta colorant and the additional amount of the crystalline polyester resin were controlled to the optimum values. While the hue of the toner was too bluish to fail to provide satisfactory reproducibility of red, good results were obtained in all the other evaluations.

### EXAMPLE 29

A magenta toner was produced under the conditions shown in FIG. 5 in the same manner as in Example 13. As shown in FIG. 5, the ratio of the additional amounts of the naphthol pigment and the quinacridone pigment was 8.1/1.9. The dispersed diameters of the naphthol pigment and the quinacridone pigment, the additional amount of the magenta colorant and the additional amount of the crystalline polyester resin were controlled to the optimum values. While the hue of the toner was too reddish to fail to provide satisfactory reproducibility of blue, good results were obtained in all the other evaluations.

### EXAMPLE 30

A magenta toner was produced under the conditions shown in FIG. 5 in the same manner as in Example 13. As shown in FIG. 5, the additional amount of the magenta colorant was 3.9% by weight. The ratio of the additional amounts of the naphthol pigment and the quinacridone pigment, the dispersed diameters of the pigments and the additional amount of the crystalline polyester resin were controlled to the optimum values. While a satisfactory image density was not obtained due to insufficient colorability, good results were obtained in all the other evaluations.

### EXAMPLE 31

A magenta toner was produced under the conditions shown in FIG. 5 in the same manner as in Example 13. As shown in FIG. 5, the additional amount of the magenta colorant was 15.1% by weight. The ratio of the additional amounts of the naphthol pigment and the quinacridone pigment, the dispersed diameters of the pigments and the additional amount of the crystalline polyester resin were controlled to the optimum values. While filming on a photoreceptor occurred due to the large amount of the colorant in the toner, good results were obtained in all the other evaluations.

### EXAMPLE 32

A magenta toner was produced under the conditions shown in FIG. 5 in the same manner as in Example 13. As shown in FIG. 5, only the naphthol pigment was strongly formed into a master batch to provide a dispersed diameter of the naphthol pigment of 0.09 μm. The ratio of the additional amounts of the naphthol pigment and the quinacridone pigment, the dispersed diameter of the quinacridone pigment and the additional amount of the crystalline polyester resin were controlled to the optimum values. While the light resistance was lowered due to color decay caused by irradiation of light, good results were obtained in all the other evaluations.

### EXAMPLE 33

A magenta toner was produced under the conditions shown in FIG. 5 in the same manner as in Example 13. As shown in FIG. 5, only the mixing time before kneading with a Henschel mixer of the naphthol pigment was decreased to provide a dispersed diameter of the naphthol pigment of 1.1 μm. The ratio of the additional amounts of the naphthol pigment and the quinacridone pigment, the dispersed diameter of the quinacridone pigment and the additional amount of the crystalline polyester resin were controlled to the optimum values. While filming on a photoreceptor occurred, good results were obtained in all the other evaluations.

### EXAMPLE 34

A magenta toner was produced under the conditions shown in FIG. 5 in the same manner as in Example 13. As shown in FIG. 5, only the quinacridone pigment was strongly formed into a master batch to provide a dispersed diameter of the quinacridone pigment of 0.04 μm. The ratio of the additional amounts of the naphthol pigment and the quinacridone pigment, the dispersed diameter of the naphthol pigment and the additional amount of the crystalline polyester resin were controlled to the optimum values. While the light resistance was lowered due to color decay caused by irradiation of light, good results were obtained in all the other evaluations.

### EXAMPLE 35

A magenta toner was produced under the conditions shown in FIG. 5 in the same manner as in Example 13. As shown in FIG. 5, only the mixing time before kneading with a Henschel mixer of the quinacridone pigment was decreased to provide a dispersed diameter of the quinacridone pigment of 0.51 μm. The ratio of the additional amounts of the naphthol pigment and the quinacridone pigment, the dispersed diameter of the naphthol pigment and the additional amount of the crystalline polyester resin were controlled to the optimum values. While a satisfactory image density was not obtained due to insufficient colorability, good results were obtained in all the other evaluations.

### EXAMPLE 36

A magenta toner was produced under the conditions shown in FIG. 5 in the same manner as in Example 13. As shown in FIG. 5, the additional amount of the crystalline polyester resin was 0.9% by weight. The ratio of the additional amounts of the naphthol pigment and the quinacridone pigment, the dispersed diameters of the pigments and the additional amount of the magenta colorant were controlled to the optimum values. While an image obtained had unsatisfactory gloss, good results were obtained in all the other evaluations.

### EXAMPLE 37

A magenta toner was produced under the conditions shown in FIG. 5 in the same manner as in Example 13. As shown in FIG. 5, the additional amount of the crystalline polyester resin was 15.1% by weight. The ratio of the additional amounts of the naphthol pigment and the quinacridone pigment, the dispersed diameters of the pigments and the additional amount of the magenta colorant were controlled to the optimum values. While the image fluctuation on environments was increased due to high hygroscopicity of the toner, good results were obtained in all the other evaluations.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developer comprising:
a core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner; and
inorganic oxide particles having a primary particle diameter of from 80 to 300 nm externally added to a surface of the core toner in an amount of from 0.1 to 5.0% by weight based on 100% by weight of the toner.

2. The developer according to claim 1, wherein an additional amount of the quinacridone pigment is from 10 to 90% by weight based on the magenta colorant.

3. The developer according to claim 1, wherein the core toner has a volume average particle diameter of from 4.0 to 12.0 μm.

4. The developer according to claim 1, wherein the toner contains a crystalline polyester resin in an amount of from 1 to 15% by weight.

5. The developer according to claim 4, wherein the quinacridone pigment has a dispersed diameter d_{q} of 0.05≦d_{q}≦0.5 μm.

6. The developer according to claim 1, wherein the toner contains the magenta colorant in an amount of from 4 to 15% by weight.

7. The developer according to claim 1, wherein the magenta colorant contains a naphthol pigment, and a ratio Cₙ/C_{q} of an additional amount Cₙ of the naphthol pigment and an additional amount C_{q} of the quinacridone pigment is from 8/2 to 2/8.

8. The developer according to claim 1, wherein the magenta colorant contains a naphthol pigment, and the naphthol pigment has a dispersed diameter dₙ of dₙ>d_{q}.

9. An image forming method comprising:
forming toner images with a yellow toner, a magenta toner, a cyan toner and a black toner on an image carrying member;
wherein the magenta toner contains a core toner and inorganic oxide particles,
the core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner,
the inorganic oxide particles having a primary particle diameter of from 80 to 300 nm externally added to a surface of the core toner in an amount of from 0.1 to 5.0% by weight based on 100% by weight of the toner; and
transferring the toner images onto a transfer medium to form an image.

10. The method according to claim 9, wherein an additional amount of the quinacridone pigment is from 10 to 90% by weight based on the magenta colorant.

11. The method according to claim 9, wherein the core toner has a volume average particle diameter of from 4.0 to 12.0 μm.

12. The method according to claim 9, wherein the toner contains a crystalline polyester resin in an amount of from 1 to 15% by weight.

13. The method according to claim 9, wherein the toner contains the magenta colorant in an amount of from 4 to 15% by weight.

14. The method according to claim 9, wherein the magenta colorant contains a naphthol pigment, and the naphthol pigment has a dispersed diameter dₙ of dₙ>d_{q}.

15. An image forming apparatus comprising:
an image carrying member configured to form toner images on the image carrying member with a yellow toner, a magenta toner, a cyan toner and a black toner;
wherein the magenta toner contains a core toner and inorganic oxide particles,
the core toner containing a magenta colorant including a quinacridone pigment, the magenta colorant having a dispersed diameter d=(major diameter+minor diameter)/2 of 0.25≦d≦0.50 μm being present in a number of from 5 to 200 per 10 particles of the core toner on observation of one sliced surface of the core toner, and the magenta colorant having a dispersed diameter d of d≧2.0 μm being present in a number of 1 or less per 10 particles of the core toner on observation of one sliced surface of the core toner,
the inorganic oxide particles having a primary particle diameter of from 80 to 300 nm externally added to a surface of the core toner in an amount of from 0.1 to 5.0% by weight based on 100% by weight of the toner; and
a transfer medium configured to transfer the toner images.

16. The apparatus according to claim 15, wherein an additional amount of the quinacridone pigment is from 10 to 90% by weight based on the magenta colorant.

17. The apparatus according to claim 15, wherein the core toner has a volume average particle diameter of from 4.0 to 12.0 μm.

18. The apparatus according to claim 15, wherein the toner contains a crystalline polyester resin in an amount of from 1 to 15% by weight.

19. The apparatus according to claim 15, wherein the toner contains the magenta colorant in an amount of from 4 to 15% by weight.

20. The apparatus according to claim 15, wherein the magenta colorant contains a naphthol pigment, and the naphthol pigment has a dispersed diameter dₙ of dₙ>d_{q}.
